(19) United States
(12) Patent Application Publication
(10) Pub. No.: US 2024/0193512 A1
(43) Pub. Date: Jun. 13, 2024

(54) Managing Multi-Party Projects for Computing Applications

(71) Applicant: SAP SE, Walldorf (DE)

(72) Inventors: Thirumaleshwar Kunamalla, Bengaluru (IN); Avishek Jana, Bengaluru (IN); Prasad Karani, Bengaluru (IN); Vijayaraj SundaraBabu, Bengaluru (IN); Amit Saxena, Bengaluru (IN); Santosh Dattatreya Murudeshwar, Bengaluru (IN); Ankur Goyal, Bengaluru (IN); Radhakrishna V Tolety, Bengaluru (IN)

(21) Appl. No.: 18/063,324

(22) Filed: Dec. 8, 2022

(51) Int. Cl. G06Q 10/0631

(52) U.S. Cl. CPC G06Q 10/06313

(57) ABSTRACT

Some embodiments provide a non-transitory machine-readable medium that stores a program. The program may receive, from a particular user, a first request to create a project. In response to the first request, the program may generate the project. The program may receive, from the particular user, a second request to add a plurality of users to the project. The program may generate a plurality of data objects, each data object in the plurality of data objects associated with the particular user and a user in the plurality of users. For each data object in the plurality of data objects, the program may receive, from the particular user, a set of access control configurations for a set of sections in the data object. The program may provide a graphical user interface (GUI) comprising the plurality of data objects.

### SUMMARY

In some embodiments, the techniques described herein relate to a non-transitory machine-readable medium storing a program executable by at least one processing unit of a device, the program including sets of instructions for: receiving, from a particular user, a first request to create a project: in response to the first request, generating the project: receiving, from the particular user, a second request to add a plurality of users to the project: generating a plurality of data objects, each data object in the plurality of data objects associated with the particular user and a user in the plurality of users: for each data object in the plurality of data objects, receiving, from the particular user, a set of access control configurations for a set of sections in the data object, each access control configuration specifying the particular user and a subset of the plurality of users that can access a corresponding section in the data object; and providing a graphical user interface (GUI) including the plurality of data objects.

In some embodiments, the techniques described herein relate to a non-transitory machine-readable medium, wherein the GUI is a first GUI, wherein the program further includes a set of instructions for providing a second GUI including user interface (UI) controls for specifying access control configurations for the set of sections in a data object in the plurality of data objects.

In some embodiments, the techniques described herein relate to a non-transitory machine-readable medium, wherein the program further includes a set of instructions for receiving a first access control configuration in the set of access control configurations for a first section in the set of sections in the data object.

In some embodiments, the techniques described herein relate to a non-transitory machine-readable medium, wherein the program further includes a set of instructions for receiving a second access control configuration in the set of access control configurations for a second section in the set of sections in the data object.

In some embodiments, the techniques described herein relate to a non-transitory machine-readable medium, wherein the first access control configuration specifies the particular user and a first subset of the plurality of users and the second access control configuration specifies the particular user and a second subset of the plurality of users, wherein the first subset of the plurality of users and the second subset of the plurality of users are different.

In some embodiments, the techniques described herein relate to a non-transitory machine-readable medium, wherein the first request specifies a name of the project, a description of the project, and a multi-party project as a project type of the project.

In some embodiments, the techniques described herein relate to a non-transitory machine-readable medium, wherein the visualization further includes a graphical representation of a status of the project.

In some embodiments, the techniques described herein relate to a method including: receiving, from a particular user, a first request to create a project: in response to the first request, generating the project: receiving, from the particular user, a second request to add a plurality of users to the project: generating a plurality of data objects, each data object in the plurality of data objects associated with the particular user and a user in the plurality of users; for each data object in the plurality of data objects, receiving, from the particular user, a set of access control configurations for a set of sections in the data object, each access control configuration specifying the particular user and a subset of the plurality of users that can access a corresponding section in the data object: and providing a graphical user interface (GUI) including the plurality of data objects.

In some embodiments, the techniques described herein relate to a method, wherein the GUI is a first GUI, the method further including providing a second GUI including user interface (UI) controls for specifying access control configurations for the set of sections in a data object in the plurality of data objects.

In some embodiments, the techniques described herein relate to a method further including receiving a first access control configuration in the set of access control configurations for a first section in the set of sections in the data object.

In some embodiments, the techniques described herein relate to a method further including receiving a second access control configuration in the set of access control configurations for a second section in the set of sections in the data object.

In some embodiments, the techniques described herein relate to a method, wherein the first access control configuration specifies the particular user and a first subset of the plurality of users and the second access control configuration specifies the particular user and a second subset of the plurality of users, wherein the first subset of the plurality of users and the second subset of the plurality of users are different.

In some embodiments, the techniques described herein relate to a method, wherein the first request specifies a name of the project, a description of the project, and a multi-party project as a project type of the project.

In some embodiments, the techniques described herein relate to a method, wherein the visualization further includes a graphical representation of a status of the project.

In some embodiments, the techniques described herein relate to a system including: a set of processing units: and a non-transitory machine-readable medium storing instructions that when executed by at least one processing unit in the set of processing units cause the at least one processing unit to: receive, from a particular user, a first request to create a project; in response to the first request, generate the project: receive, from the particular user, a second request to add a plurality of users to the project: generate a plurality of data objects, each data object in the plurality of data objects associated with the particular user and a user in the plurality of users: for each data object in the plurality of data objects, receive, from the particular user, a set of access control configurations for a set of sections in the data object, each access control configuration specifying the particular user and a subset of the plurality of users that can access a corresponding section in the data object: and provide a graphical user interface (GUI) including the plurality of data objects.

In some embodiments, the techniques described herein relate to a system, wherein the GUI is a first GUI, wherein the instructions further cause the at least one processing unit to provide a second GUI including user interface (UI) controls for specifying access control configurations for the set of sections in a data object in the plurality of data objects.

In some embodiments, the techniques described herein relate to a system, wherein the instructions further cause the at least one processing unit to receive a first access control configuration in the set of access control configurations for a first section in the set of sections in the data object.

In some embodiments, the techniques described herein relate to a system, wherein the instructions further cause the at least one processing unit to receive a second access control configuration in the set of access control configurations for a second section in the set of sections in the data object.

In some embodiments, the techniques described herein relate to a system, wherein the first access control configuration specifies the particular user and a first subset of the plurality of users and the second access control configuration specifies the particular user and a second subset of the plurality of users, wherein the first subset of the plurality of users and the second subset of the plurality of users are different.

In some embodiments, the techniques described herein relate to a system, wherein the first request specifies a name of the project, a description of the project, and a multi-party project as a project type of the project.

The following detailed description and accompanying drawings provide a better understanding of the nature and advantages of various embodiments of the present disclosure.

### BRIEF DESCRIPTION OF THE DRAWINGS

FIG. 1 illustrates a system for managing multi-party projects for computing applications according to some embodiments.

FIG. 2 illustrates an example graphical user interface (GUI) for creating a project according to some embodiments.

FIGS. 3A and 3B illustrate an example GUI for displaying information associated with a project according to some embodiments.

FIG. 4 illustrates an example GUI for specifying access control configurations for a data object according to some embodiments.

FIG. 5 illustrates a process for creating a multi-party project according to some embodiments.

FIG. 6 illustrates an exemplary computer system, in which various embodiments may be implemented.

FIG. 7 illustrates an exemplary computing device, in which various embodiments may be implemented.

FIG. 8 illustrates an exemplary system, in which various embodiments may be implemented.

### DETAILED DESCRIPTION

In the following description, for purposes of explanation, numerous examples and specific details are set forth in order to provide a thorough understanding of the present disclosure. It will be evident, however, to one skilled in the art that various embodiment of the present disclosure as defined by the claims may include some or all of the features in these examples alone or in combination with other features described below, and may further include modifications and equivalents of the features and concepts described herein.

Described herein are techniques for managing multi-party projects for computing applications. In some embodiments, a computing system may receive from a particular user a request to create a multi-party project. In response to the request, the computing system creates the project and then provides the particular user with an option to add users to the project. The computing system can receive from the particular user another request, via the option, to add several users to the project. Next, the computing system can generate several data objects. Each of the data objects is associated with the particular user and one of the users added to the project. The computing system then receives from the particular user a set of access control configurations for each of the data objects. For each data object, the respective set of access control configurations specifies which users (e.g., the particular user, the added users, etc.) can access the data object. Finally, the computing system may provide a visualization that includes the data objects.

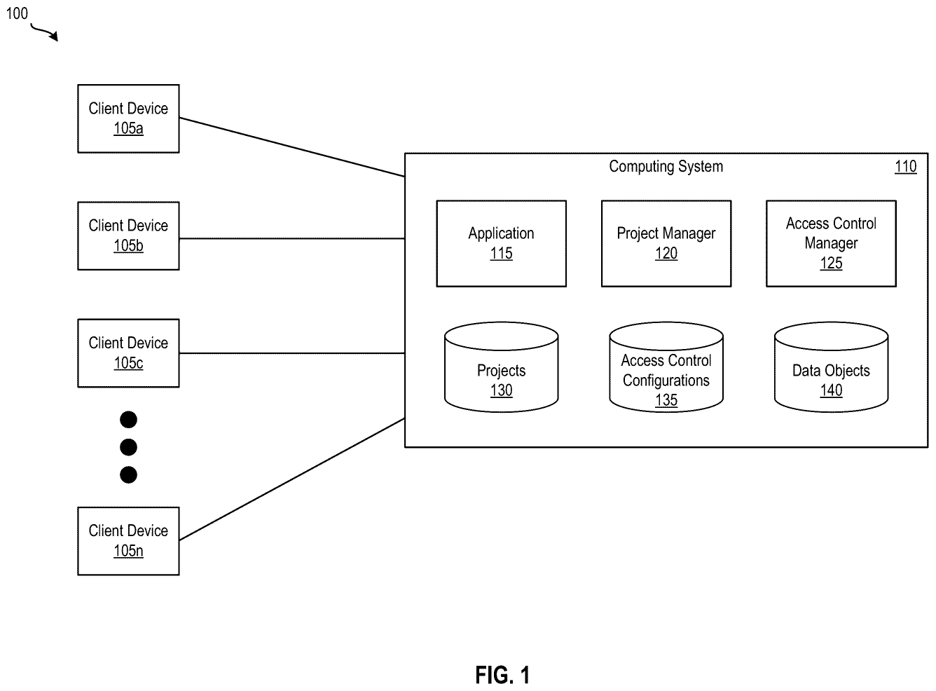

FIG. 1 illustrates a system 100 for managing multi-party projects for computing applications according to some embodiments. As shown, system 100 includes client devices 105a-n and computing system 110. Each of the client devices 105a-n is configured to interact with computing system 110. For example, a user of a client device 105 can access application 115 to create and manage multi-party projects. A user that is added to a project can interact with the project by using a client device 105 to access application 115.

As depicted in FIG. 1, computing system 110 includes application 115, project manager 120, access control manager 125, and storages 130-140. Projects storage 130 is configured to store projects. In some embodiments a project specifies a name of the project, a description of the project, a project type of the project, a set of users, a set of data objects, a set of access control configurations, etc. Access control configurations storage 135 stores access control configurations. In some embodiments, an access control configuration specifies a set of users and a set of permissions (e.g., read only, write only, read and write, etc.) for each user in the set of users. Data objects storage 140 is configured to store data objects. Examples of types of data objects include contract data objects, agreement data objects, request for proposal data objects, request for quotation data objects, request for information data objects, invitation for bid data objects, purchase order data objects, etc. In some embodiments, storages 130-140 are implemented in a single physical storage while, in other embodiments, storages 130-140 may be implemented across several physical storages. While FIG. 1 shows storages 130-140 as part of computing system 110, one of ordinary skill in the art will appreciate that projects storage 130, access control configurations storage 135, and/or data objects storage 140 may be external to computing system 110 in some embodiments.

Application 115 is a software application operating on computing system 110 that facilitates the creation and management of multi-party projects. For instance, application 115 can provide a client device 105 with a graphical user interface (GUI) for creating projects. Through such a GUI, application 115 may receive from a client device 105 a request to create a project. The request may include information associated with the project, such as a name of the project, a description of the project, a project type of the project, a set of users, a set of data objects, a set of access control configurations, etc. In response to the request, application 115 forwards the request to project manager 120 for processing. Application 115 can receive other types of requests associated with the project, such as request to add users to the project, requests to add data objects to the project, requests to create, edit, and/or delete access control configurations, requests to add access control configurations to the project, etc. Application 115 forwards these requests to project manager 120 and/or access control manager 125 to handle. In some instances, application 115 may receive requests to create data objects for the project. In response one of these requests, application 115 generates the data objects and stores them in data objects storage 140. In addition, application 115 may receive from a client device 105 a request to access a project. In response to the request, application 115 accesses projects storage 130 to retrieve the project. Next, application 115 provides the client device 105 the project via a GUI.

Project manager 120 is configured to manage projects. For example, project manager 120 may receive from application 115 a request to create a project as well as information associated with the project. In response to the request, project manager 120 generates the project based on the information associated with the project. Then, project manager 120 stores the project in projects storage 130. Additionally, project manager 120 can receive from application 115 requests to add users to a project, requests to add data objects to a project, requests to add access control configurations to the project, etc. In response one of these requests, project manager 120 accesses projects storage 130 and updates the project accordingly.

Access control manager 125 is responsible for managing access control to data objects of projects. For instance, access control manager 125 may receive from application 115 a request to create an access control configuration for a project. In response to the request, access control manager 125 generates the access control configuration and stores it in access control configurations storage 135. In cases where access control manager 125 receives from application 115 a request to edit or delete an access control configuration for a project, access control manager 125 accesses access control configurations storage 135 and updates or removes the access control configuration.

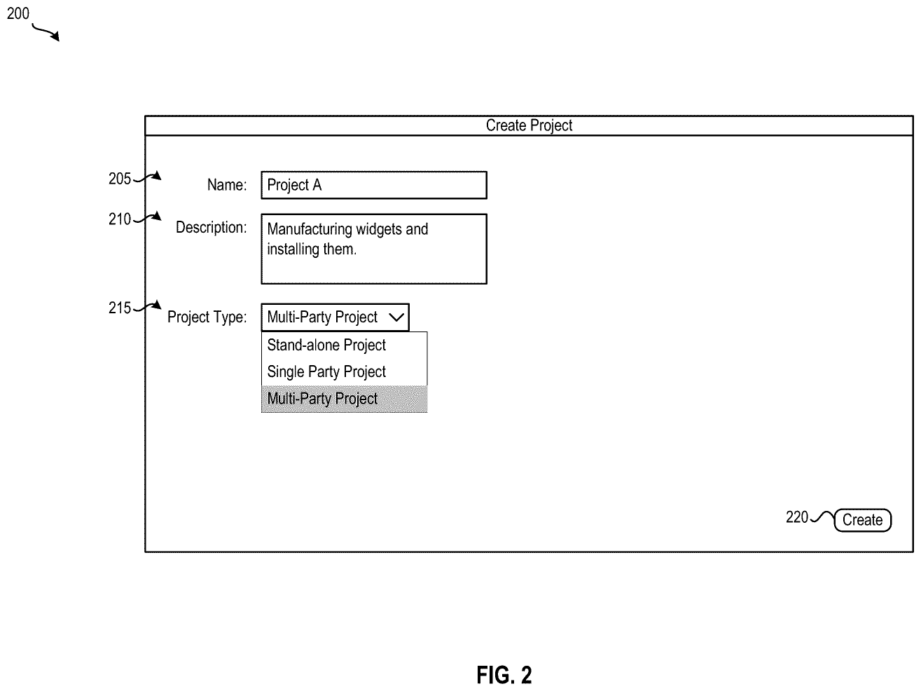

An example operation of system 100 will now be described by reference to FIGS. 1-4. The example operation will demonstrate how a multi-party project is created and managed according to some embodiments. The operation starts by a user of client device 105a accessing a GUI provided by application 115 for creating a project. FIG. 2 illustrates an example GUI 200 for creating a project according to some embodiments. For this example, application 115 provides GUI 200 to client device 105a and the user of client device 105a uses it to create a multi-party project.

As illustrated in FIG. 2, GUI 200 includes user interface (UI) controls 205-220. UI control 205 is a textbox control configured to receive a name of a project and UI control 210 is a textbox configured to receive a description of the project. Here, the user of client device 105a is a buyer that is creating a project, called “Project A,” for manufacturing widgets and installing the widgets. UI control 215 is a drop-down control configured to provide a set of project type options and receive a selection of one of the project type options. As shown, the set of options provided by UI control 215 includes a stand-alone project type, a single party project type, and a multi-party project type. In this example, the user of client device 105a selects the multi-party project type option, as indicated by the gray highlighting of the multi-party project type option. UI control 220 is a selectable UI control for creating a project. After the user of client device 105a entered the information shown in UI controls 205-215, the user selects UI control 220 to create the project. The selection of UI control 220 causes client device 105a to send application 115 the information provided via UI controls 205-215 as well as a request to create a project based on this information.

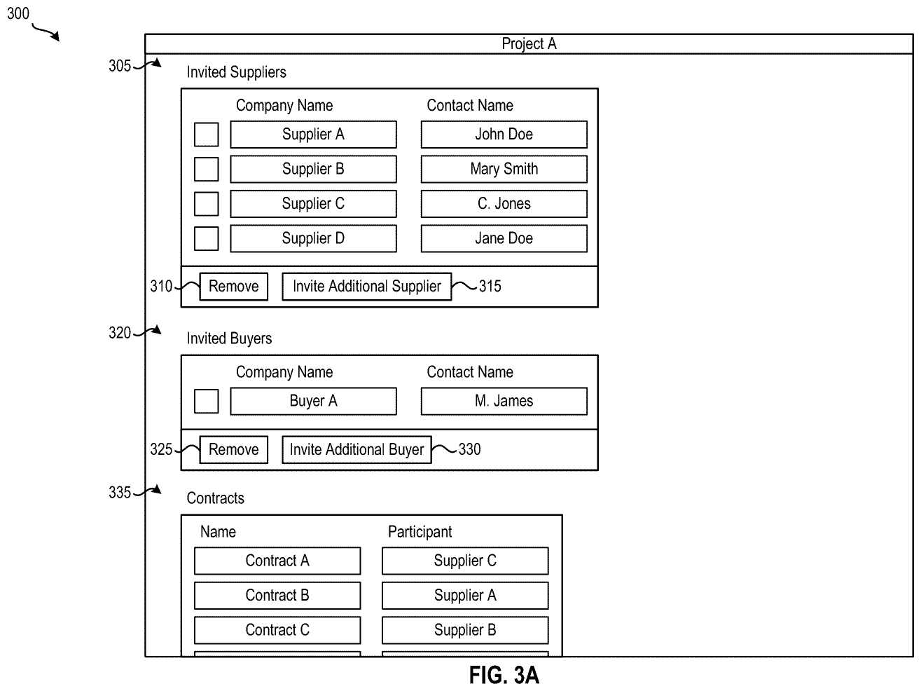

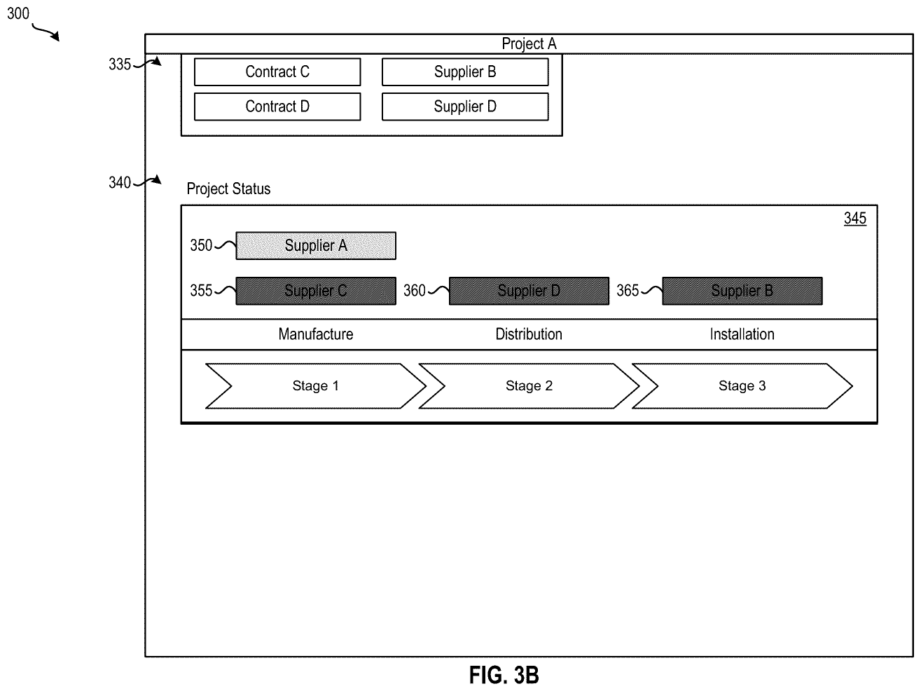

Upon receiving the request, application 115 forwards it to project manager 120. When project manager 120 receives the request and the information associated with the project (the information provided via UI controls 205-215 in this example), project manager 120 generates the project, which includes the information associated with the project, and stores the project in projects storage 130. Next, the user of client device 105a, sends application 115 a request to add users to the project. The user of client device 105a also sends application 115 a request to generate a set of data objects and a request to add the set of data objects to the project. FIGS. 3A and 3B illustrate an example GUI 300 for displaying information associated with a project according to some embodiments. Specifically, GUI 300 is used for displaying information associated with the project created in this example.

As depicted in FIG. 3A, GUI 300 includes sections 305, 320, and 335. Sections 305 and 320 are for displaying users added to the project. In particular, section 305 displays suppliers added to the project while section 320 displays buyers added to the project. For this example, Buyer A is the user of client device 105 that created the project and was automatically added to the project. The user of client device 105 added four users (Suppliers A-D in this example) to the project. As illustrated, GUI 300 also includes UI controls 310, 315, 325, and 330. UI control 310 is a selectable UI control for removing a selected supplier from the project. UI control 315 is a selectable UI control for inviting a user to the project. Once a user is invited, application 115 sends an invitation to the user. Upon receiving acceptance of the invitation from the invited user, application 115 adds the invited user to the project. UI controls 325 and 330 are similar to UI controls 310 and 315, respectively, except UI controls 325 and 330 are used for removing and inviting buyers to the project.

Section 335 of GUI 300 is for displaying the data objects added to the project. Here, the data objects are contract data objects. Each of the contract data objects specifies the buyer and one of the suppliers as parties to the contract. As shown, the Contract A data object specifies a contract between Buyer A and Supplier C, the Contract B data object specifies a contract between Buyer A and Supplier A, the Contract C data object specifies a contract between Buyer A and Supplier B. FIG. 3B shows the Contract D data object that specifies a contract between Buyer A and Supplier D. FIG. 3B also illustrates section 340 of GUI 300. Section 340 is for displaying the project status of the project. In this example, section 340) displays visualization 345, which is a graphical representation of the project status of the project. As mentioned above, the user of client device 105a is a buyer that is creating a project for manufacturing widgets and installing the widgets. The project is divided into three stages: a manufacturing stage, a distribution stage, and an installation stage. Here, Suppliers A and C have agreed to manufacture the widgets for Buyer A. Supplier D has agreed to distribute the widgets after they are manufactured by Suppliers A and C. Lastly. Supplier B has agreed to install the widgets after Supplier D has distributed them to their destinations. As depicted in FIG. 3B, visualization 345 displays the three stages of the project with labels 350 and 355 for Suppliers A and C, respectively, arranged in the first manufacturing stage, label 360 for Supplier D arranged in the second distribution stage, and label 365 for Supplier B arranged in the third installation stage.

In some embodiments, application 115 can highlight labels 350-365 differently based on the statuses of the suppliers. For example, in some such embodiments, application determines a status of a particular supplier by determining an actual time that the particular supplier completed a task (e.g., looking at a database that stores such data), and then determining the time that the particular supplier agreed to complete the task (e.g., looking at terms in the contract data object associated with the particular supplier). If the actual time is later than the agreed upon time, application 115 displays the label of the supplier using a first graphical representation. Otherwise, application 115 displays the label of the particular supplier a second graphical representation. For this example, application 115 displays a light gray highlighting for the first graphical representation and a dark gray highlight for the second graphical representation. As shown in FIG. 3B, application 115 highlighted label 350 with a light gray indicating that Supplier A has completed its task(s) on time. Application 115 highlighted label 355 with a dark gray indicating that Supplier C has not yet completed its task(s) and/or has completed its task(s) late. Since Suppliers D and B are responsible for performing tasks in the second and third stages, respectively, the delay by Supplier C has caused delays for Suppliers D and B. As such, application 115 has highlighted labels 360 and 365 to indicate these delays. In this manner, visualization 345 is able to provide a single visualization where the buyer can track the performance of suppliers in the project.

Continuing with the example, the user of client device 105a navigates to another GUI for creating access control configurations. In particular, application 115 provides the user of client device 105a with a GUI for creating access control configurations. As mentioned above, an access control configuration specifies a set of users and a set of permissions (e.g., read only, write only, read and write, etc.) for each user in the set of users. The user of client device 105a can use the GUI to specify the set of users and the set of permissions along with a request to create an access control configuration. When application 115 receives the request along with the set of users and the set of permissions, application 115 sends them to access control manager 125 for processing. In response to the request, access control manager 125 generates the access control configuration and stores it in access control configurations storage 135.

The user of client device 105a sends application 115 requests to create a contract data object to represent a contract between the Buyer A and each of the Suppliers A-D. In response to these requests, application 115 generates the contract data objects and stores them in data objects storage 140. In addition, the user of client device 105a sends application 115 a request to add the newly created contract data objects to the project in this example. In response to receiving this request, application 115 forwards it to project manager 120. Upon receiving the request, project manager 120 accesses projects storage 130 to update the project by adding the contracts data objects to the project.

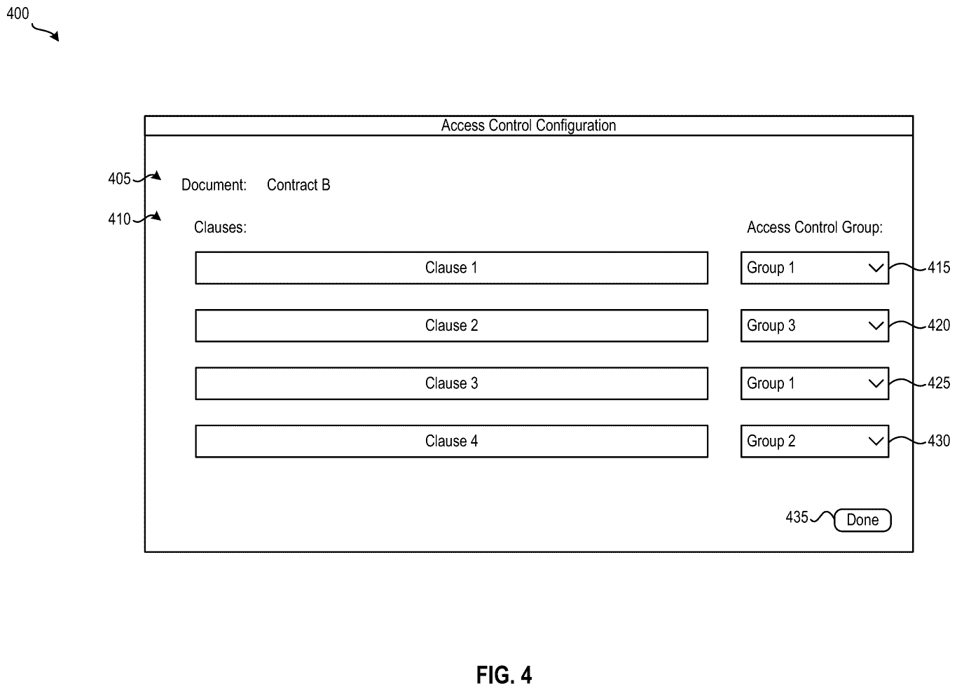

After creating contract data objects and adding them to the project, the user of client device 105a navigates to another GUI provided by application 115 that allows the user of client device 105a to assign access control configurations to a data object. FIG. 4 illustrates an example GUI 400 for specifying access control configurations for a data object according to some embodiments. As illustrated, GUI 400 includes section 405, section 410, and UI control 435. UI control 435 is a selectable UI control that, when selected, causes application 115 to save the access control configuration assignments by updating the project stored in projects storage 130.

Section 405 is for displaying the data object in the project being worked on (Contract B in this example). Section 410 shows sections of the data object and an access control configuration that is assigned to the section of the data object. As depicted in FIG. 4, an access control configuration is referred to as an access control group for this example. Section 410 also includes UI controls 415-430 for selecting an access control configuration for a section of the data object. UI control 415 is a drop-down control for selecting an access control configuration for a Clause 1 section of the Contract B data object, UI control 420 is a drop-down control for selecting an access control configuration for a Clause 2 section of the Contract B data object, UI control 425 is a drop-down control for selecting an access control configuration for a Clause 3 section of the Contract B data object, and UI control 430 is a drop-down control for selecting an access control configuration for a Clause 4 section of the Contract B data object. As shown, access control configuration Group 1 is assigned to Clauses 1 and 3, access control configuration Group 3 is assigned to Clause 2, and access control configuration Group 2 is assigned to Clause 4. Therefore, each of the users specified in access control configuration Group 1 can access Clauses 1 and 3. Each of the users specified in the access control configuration Group 2 can access Clause 4. Finally, each of the users specified in the access control configuration Group 3 can access Clause 2. That is, when a user of a client device 105 (e.g., Buyer A, Supplier A, Supplier B, Supplier C, or Supplier D) logs into application 115, application 115 may provide the client device 105 with GUI 300. The user can select one of the contract data objects in GUI 300 and, based on the access control configurations of the contract data object, application 115 will display sections of the contract data object that the user is allowed to access.

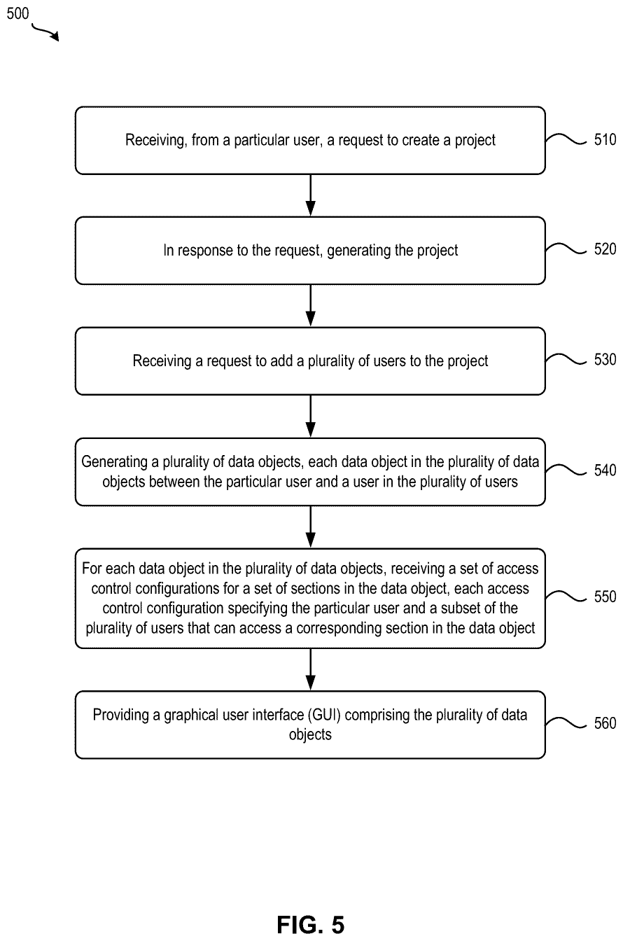

FIG. 5 illustrates a process 500 for creating a multi-party project according to some embodiments. In some embodiments, computing system 110 performs process 500. Process 500 begins by receiving, at 510, from a particular user, a first request to create a project. Referring to FIGS. 1 and 2 as an example, application 115 may receive the request from the user of client device 105a via GUI 200 when the user of client device 105a selects UI control 220.

In response to the first request, process 500 generates, at 520, the project. Referring to FIG. 1 as an example, when application 115 receives the request and the information provide via UI controls 205-215, application 115 sends them to project manager 120. In response, project manager 120 generates the project and stores it in projects storage 130. Next, process 500 receives, at 530, from the particular user, a second request to add a plurality of users to the project. Referring to FIGS. 1 and 3A as an example, application 115 may receive from the user of client device 105a a request to add the plurality of users. The user of the client device 105a can use UI control 315 to add users.

At 540, process 500 generates a plurality of data objects. Each data object in the plurality of data objects is associated with the particular user and a user in the plurality of users. Referring to FIGS. 1, 3A, and 3B as an example, application 115 can receive from the user of client device 105a requests to create several contract data objects. In response, application 115 generates the contract data objects and stores them in data objects storage 140. The user of client device 105a may also send application 115 a request to add the contract data objects to the project. Upon receiving the request, application 115 sends it to project manager 120 where project manager 120 updates the project stored in projects storage 130. The generated contract data objects are illustrated in FIGS. 3A and 3B.

For each data object in the plurality of data objects, process 500 receives, at 550, from the particular user, a set of access control configurations for a set of sections in the data object. Each access control configuration specifies the particular user and a subset of the plurality of users that can access a corresponding section in the data object. Referring to FIGS. 1 and 4 as an example, application 115 may receive from the user of client device 105a assignments of access control configurations to each of the sections in the Contract B data object, as depicted in FIG. 4.

Finally, process 500 provides, at 560, a GUI comprising the plurality of data objects. Referring to FIGS. 1, 3A, and 3B as an example, application 115 may provide GUI 300 to client device 105a, which includes contract data objects Contracts A-D.

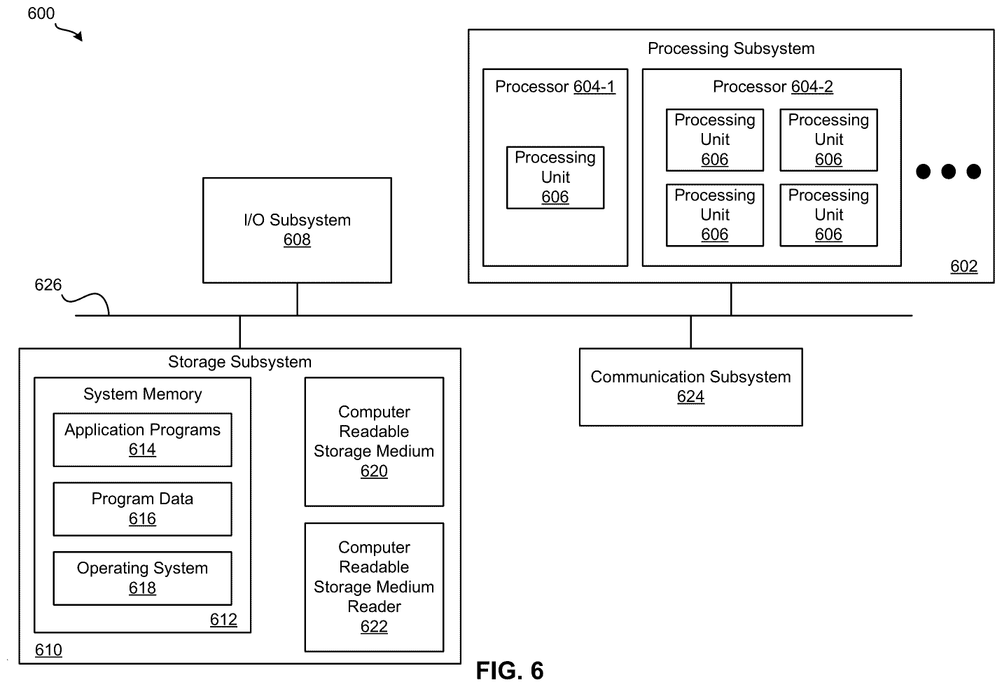

FIG. 6 illustrates an exemplary computer system 600 for implementing various embodiments described above. For example, computer system 600 may be used to implement client devices 105a-n and computing system 110. Computer system 600 may be a desktop computer, a laptop, a server computer, or any other type of computer system or combination thereof. Some or all elements of application 115, project manager 120, access control manager 125, or combinations thereof can be included or implemented in computer system 600. In addition, computer system 600 can implement many of the operations, methods, and/or processes described above (e.g., process 500). As shown in FIG. 6, computer system 600 includes processing subsystem 602, which communicates, via bus subsystem 626, with input/output (I/O) subsystem 608, storage subsystem 610 and communication subsystem 624.

Bus subsystem 626 is configured to facilitate communication among the various components and subsystems of computer system 600. While bus subsystem 626 is illustrated in FIG. 6 as a single bus, one of ordinary skill in the art will understand that bus subsystem 626 may be implemented as multiple buses. Bus subsystem 626 may be any of several types of bus structures (e.g., a memory bus or memory controller, a peripheral bus, a local bus, etc.) using any of a variety of bus architectures. Examples of bus architectures may include an Industry Standard Architecture (ISA) bus, a Micro Channel Architecture (MCA) bus, an Extended ISA (EISA) bus, a Video Electronics Standards Association (VESA) local bus, a Peripheral Component Interconnect (PCI) bus, a Universal Serial Bus (USB), etc.

Processing subsystem 602, which can be implemented as one or more integrated circuits (e.g., a conventional microprocessor or microcontroller), controls the operation of computer system 600. Processing subsystem 602 may include one or more processors 604. Each processor 604 may include one processing unit 606 (e.g., a single core processor such as processor 604-1) or several processing units 606 (e.g., a multicore processor such as processor 604-2). In some embodiments, processors 604 of processing subsystem 602 may be implemented as independent processors while, in other embodiments, processors 604 of processing subsystem 602 may be implemented as multiple processors integrate into a single chip or multiple chips. Still, in some embodiments, processors 604 of processing subsystem 602 may be implemented as a combination of independent processors and multiple processors integrated into a single chip or multiple chips.

In some embodiments, processing subsystem 602 can execute a variety of programs or processes in response to program code and can maintain multiple concurrently executing programs or processes. At any given time, some or all of the program code to be executed can reside in processing subsystem 602 and/or in storage subsystem 610. Through suitable programming, processing subsystem 602 can provide various functionalities, such as the functionalities described above by reference to process 500.

I/O subsystem 608 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, and/or any other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, and/or any other types of devices and mechanisms for outputting information from computer system 600 to a user or another device (e.g., a printer).

As illustrated in FIG. 6, storage subsystem 610 includes system memory 612, computer-readable storage medium 620, and computer-readable storage medium reader 622. System memory 612 may be configured to store software in the form of program instructions that are loadable and executable by processing subsystem 602 as well as data generated during the execution of program instructions. In some embodiments, system memory 612 may include volatile memory (e.g., random access memory (RAM)) and/or non-volatile memory (e.g., read-only memory (ROM), programmable read-only memory (PROM), erasable programmable read-only memory (EPROM), electrically erasable programmable read-only memory (EEPROM), flash memory, etc.). System memory 612 may include different types of memory, such as static random access memory (SRAM) and/or dynamic random access memory (DRAM). System memory 612 may include a basic input/output system (BIOS), in some embodiments, that is configured to store basic routines to facilitate transferring information between elements within computer system 600 (e.g., during start-up). Such a BIOS may be stored in ROM (e.g., a ROM chip), flash memory, or any other type of memory that may be configured to store the BIOS.

As shown in FIG. 6, system memory 612 includes application programs 614 (e.g., application 115), program data 616, and operating system (OS) 618. OS 618 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple IOS, Windows Phone, Windows Mobile, Android, BlackBerry OS, Blackberry 10, and Palm OS, WebOS operating systems.

Computer-readable storage medium 620 may be a non-transitory computer-readable medium configured to store software (e.g., programs, code modules, data constructs, instructions, etc.). Many of the components (e.g., application 115, project manager 120, and access control manager 125) and/or processes (e.g., process 500)) described above may be implemented as software that when executed by a processor or processing unit (e.g., a processor or processing unit of processing subsystem 602) performs the operations of such components and/or processes. Storage subsystem 610 may also store data used for, or generated during, the execution of the software.

Storage subsystem 610 may also include computer-readable storage medium reader 622 that is configured to communicate with computer-readable storage medium 620. Together and, optionally, in combination with system memory 612, computer-readable storage medium 620) may comprehensively represent remote, local, fixed, and/or removable storage devices plus storage media for temporarily and/or more permanently containing, storing, transmitting, and retrieving computer-readable information.

Computer-readable storage medium 620 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSDs), flash memory card (e.g., secure digital (SD) cards, CompactFlash cards, etc.), USB flash drives, or any other type of computer-readable storage media or device.

Communication subsystem 624 serves as an interface for receiving data from, and transmitting data to, other devices, computer systems, and networks. For example, communication subsystem 624 may allow computer system 600 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication subsystem 624 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication subsystem 624 may provide components configured for wired communication (e.g., Ethernet) in addition to or instead of components configured for wireless communication.

One of ordinary skill in the art will realize that the architecture shown in FIG. 6 is only an example architecture of computer system 600, and that computer system 600 may have additional or fewer components than shown, or a different configuration of components. The various components shown in FIG. 6 may be implemented in hardware, software, firmware or any combination thereof, including one or more signal processing and/or application specific integrated circuits.

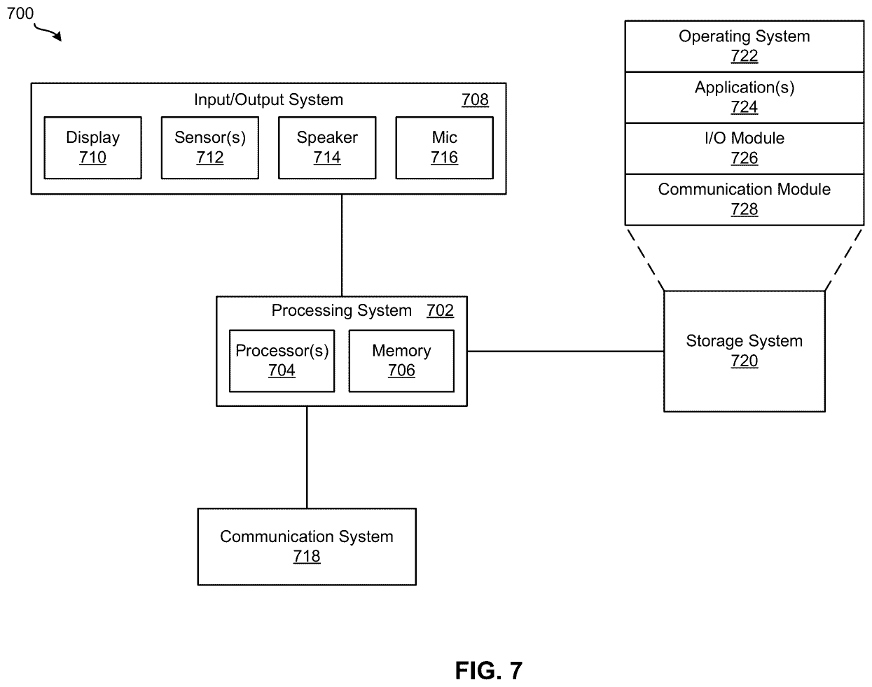

FIG. 7 illustrates an exemplary computing device 700 for implementing various embodiments described above. For example, computing device 700 may be used to implement client devices 105a-n. Computing device 700 may be a cellphone, a smartphone, a wearable device, an activity tracker or manager, a tablet, a personal digital assistant (PDA), a media player, or any other type of mobile computing device or combination thereof. As shown in FIG. 7, computing device 700 includes processing system 702, input/output (I/O) system 708, communication system 718, and storage system 720. These components may be coupled by one or more communication buses or signal lines.

Processing system 702, which can be implemented as one or more integrated circuits (e.g., a conventional microprocessor or microcontroller), controls the operation of computing device 700. As shown, processing system 702 includes one or more processors 704 and memory 706. Processors 704 are configured to run or execute various software and/or sets of instructions stored in memory 706 to perform various functions for computing device 700 and to process data.

Each processor of processors 704 may include one processing unit (e.g., a single core processor) or several processing units (e.g., a multicore processor). In some embodiments, processors 704 of processing system 702 may be implemented as independent processors while, in other embodiments, processors 704 of processing system 702 may be implemented as multiple processors integrated into a single chip. Still, in some embodiments, processors 704 of processing system 702 may be implemented as a combination of independent processors and multiple processors integrated into a single chip.

Memory 706 may be configured to receive and store software (e.g., operating system 722, applications 724, I/O module 726, communication module 728, etc. from storage system 720) in the form of program instructions that are loadable and executable by processors 704 as well as data generated during the execution of program instructions. In some embodiments, memory 706 may include volatile memory (e.g., random access memory (RAM)), non-volatile memory (e.g., read-only memory (ROM), programmable read-only memory (PROM), erasable programmable read-only memory (EPROM), electrically erasable programmable read-only memory (EEPROM), flash memory, etc.), or a combination thereof.

I/O system 708 is responsible for receiving input through various components and providing output through various components. As shown for this example, I/O system 708 includes display 710, one or more sensors 712, speaker 714, and microphone 716. Display 710 is configured to output visual information (e.g., a graphical user interface (GUI) generated and/or rendered by processors 704). In some embodiments, display 710 is a touch screen that is configured to also receive touch-based input. Display 710 may be implemented using liquid crystal display (LCD) technology, light-emitting diode (LED) technology, organic LED (OLED) technology, organic electro luminescence (OEL) technology, or any other type of display technologies. Sensors 712 may include any number of different types of sensors for measuring a physical quantity (e.g., temperature, force, pressure, acceleration, orientation, light, radiation, etc.). Speaker 714 is configured to output audio information and microphone 716 is configured to receive audio input. One of ordinary skill in the art will appreciate that I/O system 708 may include any number of additional, fewer, and/or different components. For instance, I/O system 708 may include a keypad or keyboard for receiving input, a port for transmitting data, receiving data and/or power, and/or communicating with another device or component, an image capture component for capturing photos and/or videos, etc.

Communication system 718 serves as an interface for receiving data from, and transmitting data to, other devices, computer systems, and networks. For example, communication system 718 may allow computing device 700 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication system 718 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication system 718 may provide components configured for wired communication (e.g., Ethernet) in addition to or instead of components configured for wireless communication.

Storage system 720 handles the storage and management of data for computing device 700. Storage system 720 may be implemented by one or more non-transitory machine-readable mediums that are configured to store software (e.g., programs, code modules, data constructs, instructions, etc.) and store data used for, or generated during, the execution of the software.

In this example, storage system 720 includes operating system 722, one or more applications 724, I/O module 726, and communication module 728. Operating system 722 includes various procedures, sets of instructions, software components and/or drivers for controlling and managing general system tasks (e.g., memory management, storage device control, power management, etc.) and facilitates communication between various hardware and software components. Operating system 722 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome R: OS, and the like) and/or mobile operating systems such as Apple iOS, Windows Phone, Windows Mobile, Android, BlackBerry OS, Blackberry 10, and Palm OS, WebOS operating systems.

Applications 724 can include any number of different applications installed on computing device 700. Examples of such applications may include a browser application, an address book application, a contact list application, an email application, an instant messaging application, a word processing application, JAVA-enabled applications, an encryption application, a digital rights management application, a voice recognition application, location determination application, a mapping application, a music player application, etc.

I/O module 726 manages information received via input components (e.g., display 710, sensors 712, and microphone 716) and information to be outputted via output components (e.g., display 710 and speaker 714). Communication module 728 facilitates communication with other devices via communication system 718 and includes various software components for handling data received from communication system 718.

One of ordinary skill in the art will realize that the architecture shown in FIG. 7 is only an example architecture of computing device 700, and that computing device 700 may have additional or fewer components than shown, or a different configuration of components. The various components shown in FIG. 7 may be implemented in hardware, software, firmware or any combination thereof, including one or more signal processing and/or application specific integrated circuits.

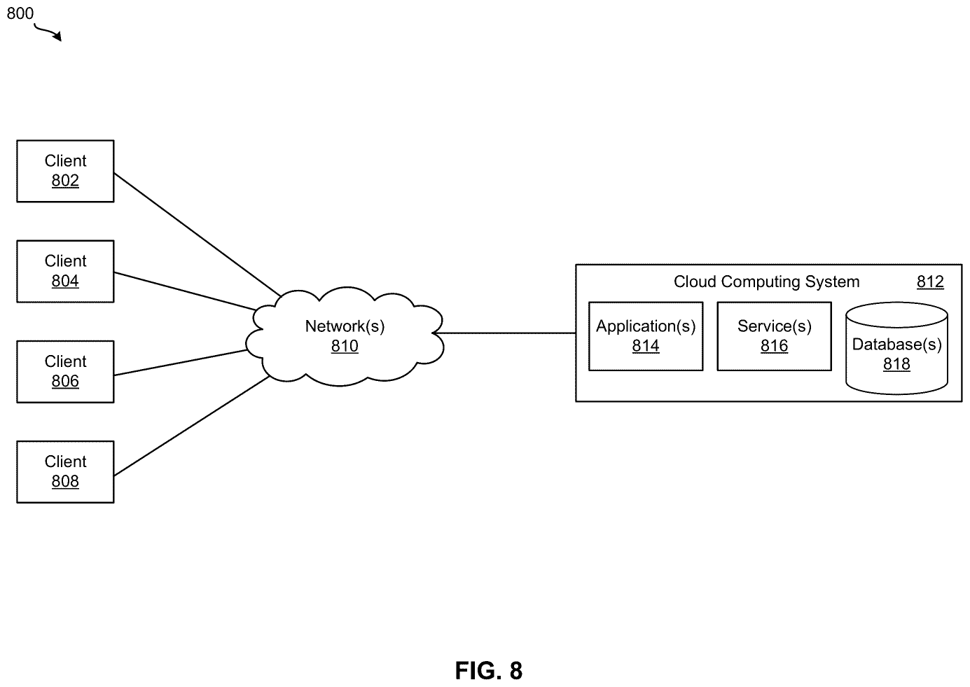

FIG. 8 illustrates an exemplary system 800 for implementing various embodiments described above. For example, client devices 802-808 may be used to implement client devices 105a-n and cloud computing system 812 may be used to implement computing system 110. As shown, system 800 includes client devices 802-808, one or more networks 810, and cloud computing system 812. Cloud computing system 812 is configured to provide resources and data to client devices 802-808 via networks 810. In some embodiments, cloud computing system 812 provides resources to any number of different users (e.g., customers, tenants, organizations, etc.). Cloud computing system 812 may be implemented by one or more computer systems (e.g., servers), virtual machines operating on a computer system, or a combination thereof.

As shown, cloud computing system 812 includes one or more applications 814, one or more services 816, and one or more databases 818. Cloud computing system 812 may provide applications 814, services 816, and databases 818 to any number of different customers in a self-service, subscription-based, elastically scalable, reliable, highly available, and secure manner.

In some embodiments, cloud computing system 812 may be adapted to automatically provision, manage, and track a customer's subscriptions to services offered by cloud computing system 812. Cloud computing system 812 may provide cloud services via different deployment models. For example, cloud services may be provided under a public cloud model in which cloud computing system 812 is owned by an organization selling cloud services and the cloud services are made available to the general public or different industry enterprises. As another example, cloud services may be provided under a private cloud model in which cloud computing system 812 is operated solely for a single organization and may provide cloud services for one or more entities within the organization. The cloud services may also be provided under a community cloud model in which cloud computing system 812 and the cloud services provided by cloud computing system 812 are shared by several organizations in a related community. The cloud services may also be provided under a hybrid cloud model, which is a combination of two or more of the aforementioned different models.

In some instances, any one of applications 814, services 816, and databases 818 made available to client devices 802-808 via networks 810 from cloud computing system 812 is referred to as a “cloud service.” Typically, servers and systems that make up cloud computing system 812 are different from the on-premises servers and systems of a customer. For example, cloud computing system 812 may host an application and a user of one of client devices 802-808 may order and use the application via networks 810.

Applications 814 may include software applications that are configured to execute on cloud computing system 812 (e.g., a computer system or a virtual machine operating on a computer system) and be accessed, controlled, managed, etc. via client devices 802-808. In some embodiments, applications 814 may include server applications and/or mid-tier applications (e.g., HTTP (hypertext transfer protocol) server applications, FTP (file transfer protocol) server applications, CGI (common gateway interface) server applications, JAVA server applications, etc.). Services 816 are software components, modules, application, etc. that are configured to execute on cloud computing system 812 and provide functionalities to client devices 802-808 via networks 810. Services 816 may be web-based services or on-demand cloud services.

Databases 818 are configured to store and/or manage data that is accessed by applications 814, services 816, and/or client devices 802-808. For instance, storages 130-140 may be stored in databases 818. Databases 818 may reside on a non-transitory storage medium local to (and/or resident in) cloud computing system 812, in a storage-area network (SAN), on a non-transitory storage medium local located remotely from cloud computing system 812. In some embodiments, databases 818 may include relational databases that are managed by a relational database management system (RDBMS). Databases 818 may be a column-oriented databases, row-oriented databases, or a combination thereof. In some embodiments, some or all of databases 818 are in-memory databases. That is, in some such embodiments, data for databases 818 are stored and managed in memory (e.g., random access memory (RAM)).

Client devices 802-808 are configured to execute and operate a client application (e.g., a web browser, a proprietary client application, etc.) that communicates with applications 814, services 816, and/or databases 818 via networks 810. This way, client devices 802-808 may access the various functionalities provided by applications 814, services 816, and databases 818 while applications 814, services 816, and databases 818 are operating (e.g., hosted) on cloud computing system 812. Client devices 802-808 may be computer system 600 or computing device 700, as described above by reference to FIGS. 6 and 7, respectively. Although system 800 is shown with four client devices, any number of client devices may be supported.

Networks 810 may be any type of network configured to facilitate data communications among client devices 802-808 and cloud computing system 812 using any of a variety of network protocols. Networks 810 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.

The above description illustrates various embodiments of the present disclosure along with examples of how aspects of the present disclosure may be implemented. The above examples and embodiments should not be deemed to be the only embodiments, and are presented to illustrate the flexibility and advantages of various embodiments of the present disclosure as defined by the following claims. Based on the above disclosure and the following claims, other arrangements, embodiments, implementations and equivalents will be evident to those skilled in the art and may be employed without departing from the spirit and scope of the present disclosure as defined by the claims.

What is claimed is:

1. A non-transitory machine-readable medium storing a program executable by at least one processing unit of a device, the program comprising sets of instructions for:
receiving, from a particular user, a first request to create a project;
in response to the first request, generating the project;
receiving, from the particular user, a second request to add a plurality of users to the project;
generating a plurality of data objects, each data object in the plurality of data objects associated with the particular user and a user in the plurality of users;
for each data object in the plurality of data objects, receiving, from the particular user, a set of access control configurations for a set of sections in the data object, each access control configuration specifying the particular user and a subset of the plurality of users that can access a corresponding section in the data object; and
providing a graphical user interface (GUI) comprising the plurality of data objects.

2. The non-transitory machine-readable medium of claim 1, wherein the GUI is a first GUI, wherein the program further comprises a set of instructions for providing a second GUI comprising user interface (UI) controls for specifying access control configurations for the set of sections in a data object in the plurality of data objects.

3. The non-transitory machine-readable medium of claim 2, wherein the program further comprises a set of instructions for receiving a first access control configuration in the set of access control configurations for a first section in the set of sections in the data object.

4. The non-transitory machine-readable medium of claim 3, wherein the program further comprises a set of instructions for receiving a second access control configuration in the set of access control configurations for a second section in the set of sections in the data object.

5. The non-transitory machine-readable medium of claim 4, wherein the first access control configuration specifies the particular user and a first subset of the plurality

1. A non-transitory machine-readable medium storing a program executable by at least one processing unit of a device, the program comprising sets of instructions for:
receiving, from a particular user, a first request to create a project;
in response to the first request, generating the project;
receiving, from the particular user, a second request to add a plurality of users to the project;
generating a plurality of data objects, each data object in the plurality of data objects associated with the particular user and a user in the plurality of users;
for each data object in the plurality of data objects, receiving, from the particular user, a set of access control configurations for a set of sections in the data object, each access control configuration specifying the particular user and a subset of the plurality of users that can access a corresponding section in the data object; and
providing a graphical user interface (GUI) comprising the plurality of data objects.

2. The non-transitory machine-readable medium of claim 1, wherein the GUI is a first GUI, wherein the program further comprises a set of instructions for providing a second GUI comprising user interface (UI) controls for specifying access control configurations for the set of sections in a data object in the plurality of data objects.

3. The non-transitory machine-readable medium of claim 2, wherein the program further comprises a set of instructions for receiving a first access control configuration in the set of access control configurations for a first section in the set of sections in the data object.

4. The non-transitory machine-readable medium of claim 3, wherein the program further comprises a set of instructions for receiving a second access control configuration in the set of access control configurations for a second section in the set of sections in the data object.

5. The non-transitory machine-readable medium of claim 4, wherein the first access control configuration specifies the particular user and a first subset of the plurality of users and the second access control configuration specifies the particular user and a second subset of the plurality of users, wherein the first subset of the plurality of users and the second subset of the plurality of users are different.

6. The non-transitory machine-readable medium of claim 1, wherein the first request specifies a name of the project, a description of the project, and a multi-party project as a project type of the project.

7. The non-transitory machine-readable medium of claim 1, wherein the GUI further comprises a visualization, the visualization comprising a graphical representation of a status of the project.

8. A method comprising:
receiving, from a particular user, a first request to create a project;
in response to the first request, generating the project;
receiving, from the particular user, a second request to add a plurality of users to the project;
generating a plurality of data objects, each data object in the plurality of data objects associated with the particular user and a user in the plurality of users;
for each data object in the plurality of data objects, receiving, from the particular user, a set of access control configurations for a set of sections in the data object, each access control configuration specifying the particular user and a subset of the plurality of users that can access a corresponding section in the data object; and 11 providing a graphical user interface (GUI) comprising the plurality of data objects.

9. The method of claim 8, wherein the GUI is a first GUI, the method further comprising providing a second GUI comprising user interface (UI) controls for specifying access control configurations for the set of sections in a data object in the plurality of data objects.

10. The method of claim 9 further comprising receiving a first access control configuration in the set of access control configurations for a first section in the set of sections in the data object.

11. The method of claim 10 further comprising receiving a second access control configuration in the set of access control configurations for a second section in the set of sections in the data object.

12. The method of claim 11, wherein the first access control configuration specifies the particular user and a first subset of the plurality of users and the second access control configuration specifies the particular user and a second subset of the plurality of users, wherein the first subset of the plurality of users and the second subset of the plurality of users are different.

13. The method of claim 8, wherein the first request specifies a name of the project, a description of the project, and a multi-party project as a project type of the project.

14. The method of claim 8, wherein the GUI further comprises a visualization, the visualization comprising a graphical representation of a status of the project.

15. A system comprising:
a set of processing units; and
a non-transitory machine-readable medium storing instructions that when executed by at least one processing unit in the set of processing units cause the at least one processing unit to:
receive, from a particular user, a first request to create a project;
in response to the first request, generate the project;
receive, from the particular user, a second request to add a plurality of users to the project;
generate a plurality of data objects, each data object in the plurality of data objects associated with the particular user and a user in the plurality of users;
for each data object in the plurality of data objects, receive, from the particular user, a set of access control configurations for a set of sections in the data object, each access control configuration specifying the particular user and a subset of the plurality of users that can access a corresponding section in the data object; and
provide a graphical user interface (GUI) comprising the plurality of data objects.

16. The system of claim 15, wherein the GUI is a first GUI, wherein the instructions further cause the at least one processing unit to provide a second GUI comprising user interface (UI) controls for specifying access control configurations for the set of sections in a data object in the plurality of data objects.

17. The system of claim 16, wherein the instructions further cause the at least one processing unit to receive a first access control configuration in the set of access control configurations for a first section in the set of sections in the data object.

18. The system of claim 17, wherein the instructions further cause the at least one processing unit to receive a second access control configuration in the set of access control configurations for a second section in the set of sections in the data object.

19. The system of claim 18, wherein the first access control configuration specifies the particular user and a first subset of the plurality of users and the second access control configuration specifies the particular user and a second subset of the plurality of users, wherein the first subset of the plurality of users and the second subset of the plurality of users are different.

20. The system of claim 15, wherein the first request specifies a name of the project, a description of the project, and a multi-party project as a project type of the project.
